(19) United States
(12) Patent Application Publication
(10) Pub. No.: US 2004/0185326 A1
(43) Pub. Date: Sep. 23, 2004

(54) Fuel cell and method for manufacturing such a fuel cell

(76) Inventors: Franz-Josef Wetzel, Gernlinden (DE); Rudolf Henne, Boeblingen (DE); Erich Bittner, Stopfenheim (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/733,465

(22) Filed: Dec. 12, 2003

Related U.S. Application Data
(63) Continuation of application No. PCT/EP02/06453, filed on Jun. 12, 2002.

(30) Foreign Application Priority Data
Jun. 13, 2001 (DE) 101 28 786.0

(51) Int. Cl. H01M 4/86; H01M 8/02; B05D 5/12

(52) U.S. Cl. 429/44; 429/38; 427/115

(57) ABSTRACT

For manufacturing an individual fuel cell, first a knit or a similar porous support structure, such as, for example, a fabric, weave or plait of one or more metal wires is produced, upon which subsequently an cathode-electrolyte-anode unit is applied coat-by-coat and step-by-step. A fuel cell stack can then be assembled from the individual cells, with the individual cells separated from one another by bipolar plates. Locally different resistances to flow are provided to influence the reaction sequence in the individual fuel cell in a desired manner.

### CROSS-REFERENCE TO RELATED APPLICATIONS

This application is a continuation of PCT Application No. PCT/EP02/06453, filed on Jun. 12, 2002.

### BACKGROUND AND SUMMARY OF THE INVENTION

This application claims the priority of German patent application 101 28 786.0, filed Jun. 13, 2001, the disclosure of which is expressly incorporated by reference herein.

Fuel cells are electrochemical devices which transform chemical energy directly into electrical current. For this purpose, fuel is fed continuously to the so-called individual (fuel) cells on an anode side and oxygen or air on a cathode side. The basic principle utilizes a spatial separation of the reaction partners by an electrolyte that is conductive for ions or protons, but not for electrons. In this manner, oxidation and reduction reactions occur at various places, namely at the anode on one side and at the cathode on the other, wherein the electron exchange thus caused between the oxidizing agent and the reducing agent takes place via an external circuit. To this extent, the fuel cell is part of a circuit.

A fuel cell unit consists of several parallel and/or serially connected individual cells, each of which comprises an electrolyte electrode unit (also designated as CEA=cathode-electrolyte-anode), as a function of desired output and voltage. The individual cells are connected to one another via electrically conductive end or intermediate plates (so-called bipolar plates) and assembled into a stack. With previous designs, gaseous reagents are distributed over grooves milled into the bipolar plates on the electrode surfaces of the reaction layers. The manufacture of these milled grooves is very costly. At the same time, fuel cells manufactured in this manner have a relatively low weight-specific and volume-specific power density as a consequence of the large area coverage of the reaction layers and the associated impediments to mass transfer.

A fuel cell construction is known in which the cathode-electrolyte-anode layers, which form the aforementioned CEA, are applied to a porous solid substrate that serves as a support layer. In such a design for an individual fuel cell, thermo-mechanical tensions arise, which originate through different heat expansions of the cathode, electrolyte and anode layers and from the porous solid substrate. In addition, different reaction temperatures arise due to different reaction rates over a single support layer plate, also causes lead to thermo-mechanical tensions. As a result of these thermo-mechanical tensions, considerable impairments of function can occur due to damage to the individual cell. In particular, when a fuel cell of this type is used in the field of motor vehicle technology, in which additional stresses occur due to vibrations during travel, this problem is worsened even further.

One object of the present invention therefore, is to provide a fuel cell and a method for manufacturing it, in which the aforementioned problems are eliminated and an economical method of production can be guaranteed.

This and other objects and advantages are achieved by the fuel cell apparatus and method according to the invention, in which a supporting structure constructed of metal wire or metal wires are provided for individual fuel cells, and the anode-electrolyte-cathode unit is applied to the supporting structure. The use of such a supporting structure consisting of wires (and consequently porous by nature), which can preferably be constructed in the form of a metal knit (but may also be designed in the form of a metallic weave or fabric or plait) provides considerable advantages in the most varied areas. One chief advantage is a certain free mobility in all three dimensions, as a result of which the supporting structure then possesses a three-dimensional elasticity and mobility. Thus, various heat expansions for the cathode-electrolyte-anode coating (CEA) to the surrounding metal structures can be compensated for by deformation or shifting of the individual wires within the supporting structure (for example the loops of a knit). Especially the tractive forces critical for ceramic structures (the anode electrolyte cathode unit forms such a thing) can be held to an acceptable level

In one especially advantageous embodiment of the invention, a porous support structure constructed of metal wire or metal wires that is functionally subjected to the flow of the reaction fluid(s) of the fuel cell offers the possibility of a selective distribution of the (gaseous) reagents over the active surface of the CEA. Because a knit or similar design, for example a weave, fabric, or plait, is permeable to flow, and the so-called reagent fluids are able to flow through the knit or similar design (i.e., through the porous supporting structure) gradations in the various directions of expansion or flow can be attained by means of a suitable structure, and especially by means of a locally different construction of the support structure. In this manner, a different flow resistance can be exposed to the fluid flowing through in different regions and/or different directions. For this, for example, the (free) flow cross sections in the support structure can be selectively different over wide areas. Different rates of flow therewith occur in various regions of the support structure.

As a result, the reaction behavior is selectively adjustable over the active surface of the CEA unit. For example, it can be ensured that in the feeding region of the individual fuel cell in which a large amount of fresh reaction fluid is available, the readiness to react is dampened since a relatively high rate of flow is imprinted on this reactive fluid in a direction parallel to the active surface of the CEA unit, and/or in that a relatively high resistance to flow running in a flow direction opposite to the CEA unit opposes the reaction fluid. Conversely, for example, the readiness to react can be increased in the exhaust region of the individual fuel cell in which only a small amount of fresh reaction fluid is available, in that this reaction fluid is imprinted with a relatively low rate of flow in a direction parallel to the active surface of the CEA unit, and/or in that the reaction fluid is opposed by a relatively low resistance to flow running in a direction toward the CEA unit. With such a selective adjustment of the reaction behavior over the surface of the CEA unit, the structure of thermal tensions can be selectively diminished or avoided to a certain, sufficient extent, so that the previously mentioned problems with the known state of the art can be avoided.

To achieve the above-mentioned different flow conditions or flow rates in the respectively desired manner, the support structure or the knit or similar construct can, for example, be “graded” in its direction of flow, such that the free or effective flow cross section diminishes within the support structure or the knit toward the cathode-electrolyte-anode unit. This can be done, for example, via a change in the mesh width in the knit and/or the thickness of the wire used to form the support structure, the component density, the shape of the mesh, the loop arching in the knit or similar construct, and/or the surface condition of the wires used. Thus the knitting method can be correspondingly adapted based upon the desired flow effects in the case of a knit, so that the wires can be knitted suitably or selectively with one another with a view toward the desired so-called “grading.”

In this connection it should be pointed out that, for the sake of simplicity, in many instances only a knit or generally a support structure will be referred to, without the intent of ruling out the other variants mentioned, such as a fabric, or a weave, or a plait of metallic wires. The terms “support structure” or “knit” are used herein to refer to a porous support structure of the invention for the CEA unit of an individual fuel cell, which is constructed of one or more metal wires in the form of a knit or weave or fabric or plait.

Returning to the so-called gradation in the support structure (i.e., locally different flow resistances for the reaction fluid), it is also possible to attain a so-called gradation of the support structure in a direction parallel to the contact plane of the cathode-electrolyte-anode unit, or to vary the flow resistance in this direction selectively. For example, a homogenization of material turnover and energy release can be attained through such a change of the free or effective flow cross section in the direction of flow of the reagents and reactions products since, for example, the effects that ensure extended reaction times (due to the decrease in rate) can be compensated for, as a result of depleted media, with a broadening of flow in the direction of flow. Once again the gradation, and hence the change in flow cross section, can be attained in the subsequent direction of flow of a reagent by the corresponding construction of the knit (for example), in other words by means of different mesh widths, wire thicknesses, component density, mesh shape, loop arching and/or surface condition of the wires.

Moreover, suitable channels can also be constructed in the knit or support structure, the free channel cross-section of which changes over the length of the channel, wherein the channels diverge or converge. If these channels are provided on the surface of the support structure, then it is possible to bring about the above-named different flow conditions by imprinting or pressing in (profiling) corresponding channels on or in the support structure, for example, by stamping or rolling.

In one preferred embodiment, the wires of the support structure can be comprised of nickel, ferritic, or austenitic alloys, or of a material containing these elements or alloys. For example, NiFe22, Inconel, FeCr alloy, or high-grade steel can be used. The material nickel specifically improves the reaction kinetics of the anode of the above-mentioned CEA lying on the support structure (in the finished individual fuel cell). Moreover, the wires can be coated with a corrosion-resistant material to prevent corrosion caused by the gaseous reagents, even in high temperature fuel cells. In addition, it is possible to combine wires of different material. For example, different wires can be joined together on or in the support structure and, for example, can be suitably locally arranged with respect to their effect on the reactions taking place.

One particularly preferred method for applying the cathode-electrolyte-anode layer(s) to the support structure involves a thermal coating method. Thus, for example, a flame spraying method (simple flame spraying: High velocity oxygen flame spraying) or a plasma spraying method (atmospheric plasma spraying, vacuum plasma spraying, low pressure plasma spraying) can be used. The plasmas can be generated, for example, using a direct voltage or by high frequency excitation, wherein it is possible to rely upon powders, suspensions, liquid and/or gaseous initial materials for layer generation. In using a vacuum plasma spraying method or a low pressure plasma spraying method, the plasma sources can be provided with high pressure jets, whereby at a reactor pressure having a range of under 1 bar, for example between 50 and 300 mbar, the generation of very dense layers is possible.

Proceeding from a suitably prefabricated knit or similar construct, it is possible to begin with the anode on one knit side or support structure side for manufacturing an individual fuel cell according to the invention with the construction of the coating for the anode electrolyte cathode unit, wherein the knit or the support structure can be slightly compacted in this region or treated further, as will be explained in greater detail below. Nickel or a NiAl allow mixed with ZrO₂, for example, can serve as the anode initial material. If a NiAl alloy is used, the aluminum can, for example, be dissolved out with potassium hydroxide, so that a firmly bound, highly conductive, highly porous nickel ZrO₂ composite layer is created. In this connection it should be pointed out that a so-called anode base layer or so-called cover layer can be applied as a first layer to the support structure, upon which then the actual active anode is applied. For the anode base layer or cover layer, once again nickel, a nickel alloy, or a nickel aluminum alloy can be used. A better, even distribution of the electrons of the fuel cells reagents can arise on this plane with the help of such an anode base layer or cover layer.

Next, the electrode layer, and subsequently the second electrode layer (which, according to the previous description, is the cathode layer) can be applied to the suitably applied first electrode layer (which, according to the previous description, is the anode layer), forming a complete cathode-electrode-anode unit on the knit. (It should be noted, however,) that the cathode layer of this so-called CEA can also be applied to the knit as a first layer, after which the electrolyte layer and then the anode layer are applied.

In order, for example, to be able to use a plasma spraying method to apply an electrode (anode or cathode) to the knit, the affected knit side can and should be correspondingly prepared in advance, in order to prevent the electrode material from penetrating too far into the knit and stopping this up during spraying. For this purpose, so-called “spraying barriers,” “stream brakes” or “stream stoppers” can be used. These designations are all directed toward measures in which a layer is arranged on or in the region of the knit surface or support structure surface on which the anode (and if necessary also the cathode) is applied, which will prevent spraying or streaming through the knit or support structure. For manufacturing such a spraying barrier, additional wires in the vicinity of the surface of the knit or the support structure can be woven, drawn, plaited or knit in, for example, with such wires consisting of a soluble material so that they can be subsequently removed again. Aluminum, for example, is suitable as a material for such wires, which can be washed out again using potassium hydroxide. Alternatively, the wires forming this so-called spraying barrier can be comprised of carbon, which can be removed, i.e. almost burned out, at high temperatures, for example using oxygen or hydrogen.

It is also possible to introduce a suitable (for example pasty) filling compound on the side of the knit (or similar construct) that faces the anode electrolyte cathode unit, as so-called stream stoppers or spraying barriers. If necessary, the latter can be dried or hardened and burned out again after the electrode layer(s) are applied, or can be removed in some other suitable manner. This filler compound which almost forms a cover layer can, for example, be formed by a so-called slop (this is an elutriation material, like an elutriation plaster) for example on a graphite base owing to the possibility of burning out. A ceramic slop may also be used as a pasty filler compound in addition to a metallic slop, especially in the region of the crude knit structure or porous support structure of the invention. A ceramic filler compound can also be washed out again following manufacture of the individual cell.

According to another preferred embodiment, the support structure is laid upon a dense, uncoated foundation and is irradiated from the opposite side with a thermal spraying method, so that a depositing takes place in the region of the dense foundation or a so-called cover layer is formed there in the support structure. This method has the advantage that an anode material can already be used as the irradiation material, so that a subsequent removal of a stream brake is no longer necessary. In addition, a graphite foil can also be used as a “spraying barrier” or “stream brake” that is inserted (for example, rolled in) into the first knit layer, wherein, in order to assure electrical contacting between an electrode and the uppermost wire loops or wire regions, the latter, for example, can be brushed free.

In order to obtain as smooth a surface as possible between the electrode or anode and the support structure side that faces it, the support structure can be stretched over a convex foundation surface when the electrode material is applied via the proposed (plasma) spraying method, since then a subsequent straightening on a plane will close any pores in the surface.

To improve the stability or the accuracy to gauge of the support structure, and to obtain as low an electrical resistance as possible inside the support structure, the individual wires lying one upon the other and forming the support structure are preferably firmly joined to one another at their contact points.

This connection can be achieved via gluing, soldering, sintering or welding. Sintering in a suitable furnace at high temperatures can preferably be conducted under a suitable contact pressure.

A welding as mentioned above of the individual wires of the support structure at their respective contact sites can, for example, be accomplished by means of resistance welding, in which a current impulse flows through the support structure on its upper and lower sides with the aid of two metal electrodes. Preferably this welding takes place in a protective atmosphere or in a vacuum. Linear electrodes, plates, or rollers can be used as welding electrodes. To avoid welding the support structure to the electrodes, the electrode surfaces should be correspondingly fashioned, having, for example, corresponding coatings which prevent welding or as low a transition resistance to the support structure as possible so that hardly any ohmic heat is released on the contact surface.

In order, in particular, to accommodate thermal stresses during the thermal coating processes with the electrode material, measures for increasing the strength of the support structure can be provided. In this way, a buckling and a warping of support structure (which is, for example, under a tensile load), can be prevented. Metal wire skeletons or wire lattices, for example, can be used as such strength-increasing elements. Longitudinal wires may also be suitably incorporated. Moreover, the wire spacing can be selected in the range from 0.5 to 20 mm, for example. In addition, it is also possible to use woven-in edge bands or edge strips, made of metal foil for example, to increase the rise in strength of the support structure. The edge bands or edge strips could then be removed following the coating process, or could be left on the support structure and used to seal the edges of the individual fuel cell.

In this connection it should be pointed out that the edge, for example, of the knit can also be suitably extruded to form a so-called edge band to form an individual fuel cell of which then several can be assembled into a so-called stack. For example, with this edge band, the knit (after the anode electrolyte cathode unit has been applied to it in the manner described) can then be welded, on the side that lies opposite this unit, to the bipolar plate mentioned initially (or otherwise suitably joined in a form-locking or substance-locking manner). This has the advantage that no independent sealing is necessary between the edge of the knit and the bipolar plate, especially if this connection, for example, is also sealed simultaneously with the production of the electrolyte coat of the CEA unit using the electrolyte material.

It should also be mentioned in this connection that the knit or the support structure can be connected in its entirety with the bipolar plate using a method that will guarantee current conductance, such as cold welding, welding, soldering and sintering. Such methods are matured and optimally developed for series production. Moreover, the current conductance mentioned assures that electrical current can not only be generated, but also transferred as desired from individual cell to individual cell.

In order to improve contacting between the knit and the anode-electrolyte-cathode unit, or as so-called spraying barriers or stream brakes, and/or as a stiffening measure for the support structure with respect to the anode-electrolyte-cathode unit to be installed, the intermediate spaces of the support structure layer or the knit near the anode can be filled by a filler compound mixed with pore formers which is preferably electrically conducting, whereby this filler mass then remains in the knit or in the support structure (i.e., it is not removed following application of the electrode layer or layers) in contrast to the spraying barriers or stream brakes mentioned initially. A suitable high-grade steel paste, for example, can be used as a filler compound of this type, which, for example, can be transformed by sintering to a porous support for the (aforementioned) CEA electrode unit.

But the knit layer (or similar construct) that is near the electrode can also be sintered prior to application of the electrode coat with a thin porous cover layer, comprised, for example, of metallic, ceramic or metallic-ceramic material, which also increases the stability of the knit in this region. A porous foil, especially comprised of an electrically conductive material, can be applied in a comparable manner, especially to the anode side of the knit prior to application of the electrode layer, so that the porosity of the foil can be generated following its application, especially mechanically or electrochemically or thermally (in that a so-called pore former is introduced into the foil). Moreover, as is apparent, such pores are necessary to enable the desired passage of the reagents between the knit (or generally the support structure) and the adjacent electrode layer.

As mentioned previously, the material composition of the support structure can change locally, in addition to the cross section change of the wire. In this way, the internal gas reformation can also be controlled on the anode side, which progresses endothermally and is brought about especially by nickel (i.e., nickel acts as a catalyst). A diminished nickel surface component in the so-called fuel gas intake of the fuel cell alters the reformation process and therewith the readiness to react of the fuel gas in the fuel cell, and therewith brings about almost a cooling down, which causes a local output reduction of the cell. The structure and the material composition of the support structure are therefore generally parameters with which the reformation process, substance transformation and output release of the individual fuel cell can be made comparable.

The structure of the above-described individual cell makes an especially efficient manufacturing process possible. This manufacturing process can progress continuously. First, a knit band or support band structure can be continuously manufactured from an individual wire, in which the desired so-called gradations for forming locally different flow resistances (as was thoroughly explained above), and the welds or generally the connections between the individual wire crossing points are realized. The knit band (or similar construct) formed in this manner can then be continuously processed further, wherein the aforementioned anode layers, electrolyte layers and cathode layers can be continuously applied one after another. Finally, the individual fuel cells can be fashioned from this so-called fuel cell band formed in this manner by cutting.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic partial section view through an individual fuel cell arranged on a bipolar plate (as section A-A from FIG. 2);

FIG. 2 is a plan view of the knit of this individual cell with imprinted diverging flow channels (in accordance with section B-B from FIG. 1); and

FIG. 3 is a schematic representation of a manufacturing method according to the invention.

### DETAILED DESCRIPTION OF THE DRAWINGS

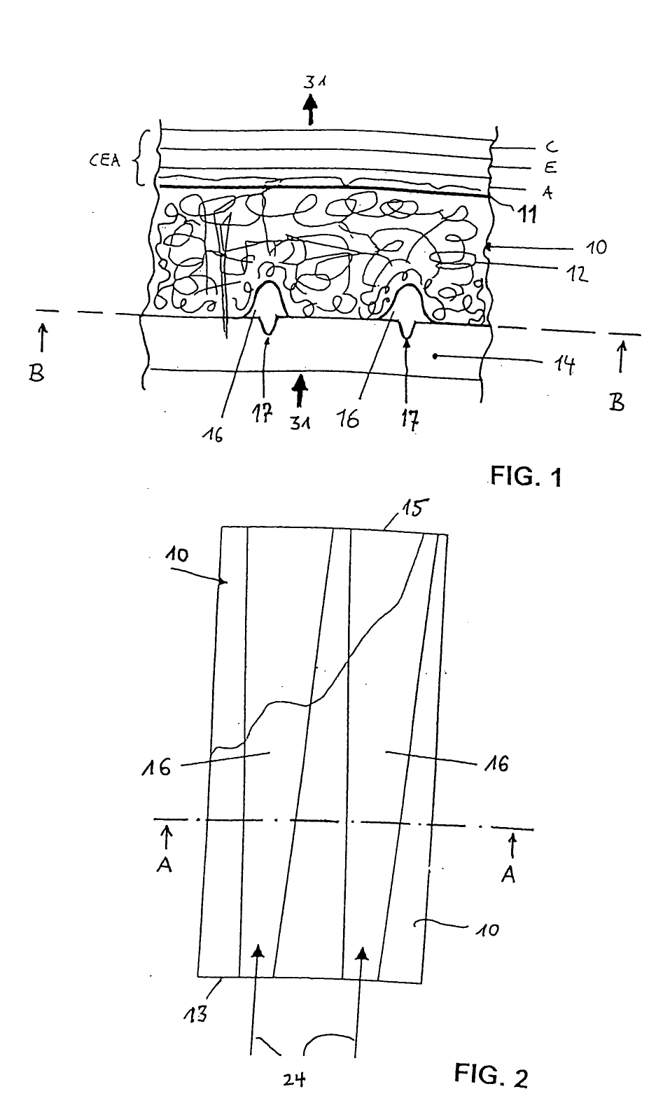

The structure of an individual fuel cell is represented in a partial section view in FIG. 1. (A so-called stack of an entire fuel cell unit is assembled from several such individual fuel cells.) The individual cell comprises a knit 10 of metal wire 12, which serves as a support structure for the cathode-electrolyte-anode unit CEA arranged thereupon, wherein the letter C designates the cathode, the letter E the electrolyte, and the letter A designates the anode. A usual bipolar plate 14 such as is customary in the configuration of fuel cells or individual fuel cells is situated on the side of the knit 10 opposite the CEA unit.

If the present individual fuel cell is one of a so-called SOFC (Solid Oxide Fuel Cell) and thus a high temperature fuel cell, the ceramic solid ZrO₂ with (Y₂O₃) stabilization, for example, can be used as the electrolyte. (This electrolyte is conductive for oxygen ions.) Chiefly Ni—YSZ, for example, is used for the anode layer. A persoscitic oxide, for example, LSM, can be used for the cathode layer. The electrochemical processes in current generation will not be delved into in greater detail here since this is known to the specialist. As is well known, a flow of electric current in accordance with the arrows 31, or a corresponding electric voltage potential, can be generated on the basis of these processes in the individual fuel cell if on the anode side (A) of the CEA a suitable fuel gas and on the cathode side (C) of the CEA unit air oxygen are brought into contact. At least the fuel gas is guided through the knit 10, which in the representation according to FIG. 1 is perpendicular to the drawing plane. The fuel gas is thus guided between the CEA unit and the bipolar plate 14. In FIG. 2, the fuel gas flows in the direction of the arrows 24 into the knit 10, wherein the so-called fuel gas intake is consequently situated at the (lower) corner 13 (FIG. 2).

The wire 12 from which the knit 10 is made comprises a nickel alloy, so that a corrosion resistance to the reagents introduced (from the fuel gas as well as from and toward the air) exists. As was explained above, the knit 10 is “graded” with respect to its thickness or density, both in the direction of the arrow 31 toward the CEA layer (in the propagation direction of the reagents), and in the direction of the main flow of the fuel gas (in FIG. 1 perpendicular to the drawing plane, in FIG. 2 in the direction of the arrow 24), with respect to the flow cross section, such that a locally different resistance to flow exists. Inside the knit 10, the mesh density of the knit 10 is locally different (which is not apparent on the basis of the figure representation) to attain this so-called gradation. As was also already explained, the individual wires 12 of the knit 10 are connected to one another by a welding process or similar process, so that the lowest possible electrical resistance for guiding the electric current (in accordance with the arrow 31) is attained.

Channels 16 are formed on the (under) side of the knit 10, which lies opposite the CEA unit, which channels run in the direction of flow 24 of the fuel gas and consequently distribute this better over the entire surface or the entire volume of the knit 10. Channels 17 corresponding with this can (as usual) be provided in the surface of the bipolar plate 14 that faces the knit 10. As shown in FIG. 2, at least the channels 16 (formed in the knit 10, for example, by impressing) diverge (i.e., widen in respect to cross section) in the direction of flow 24, so that there exists a higher rate of flow in the vicinity of the fuel gas intake (corner 13) than in the opposite exit region 15 of the individual fuel cell. Viewed in the direction of flow 24 over the length of the individual cell, this leads to a higher homogenization of the material transfers and energy release. The rate of fuel gas flow is diminished over the length of the individual cell with this broadening, and going along with this, the static pressure of the reagents is evened out over the path of flow through the anode, evening out the output density over the entire individual fuel cell.

In FIG. 1, the individual fuel cell consisting of the knit 10 and the CEA unit is arranged on a bipolar plate 14, as was already mentioned. By sequentially arranging several such bipolar plates/knit-CEA-cells, an arbitrary stack of individual cells can be built up, which then overall forms the core region of a fuel cell. Of course, care must still be taken (in the known manner) that a flow channel is also formed between a bipolar plate that borders on the cathode side or cathode layer of the CEA unit of a further individual cell above the individual cell represented in FIG. 1 and the cathode layer C of the individual cell represented in the figure. This can also be realized by a knit insert, for example. In addition, a gas-tight seal between the individual cells must be guaranteed, and the provision of electric current (for example, through a cathode-side knit insert or a conductive paste) must be assured. Nonetheless, at present these features will not be delved into in greater detail, as they are sufficiently known from the state of the art.

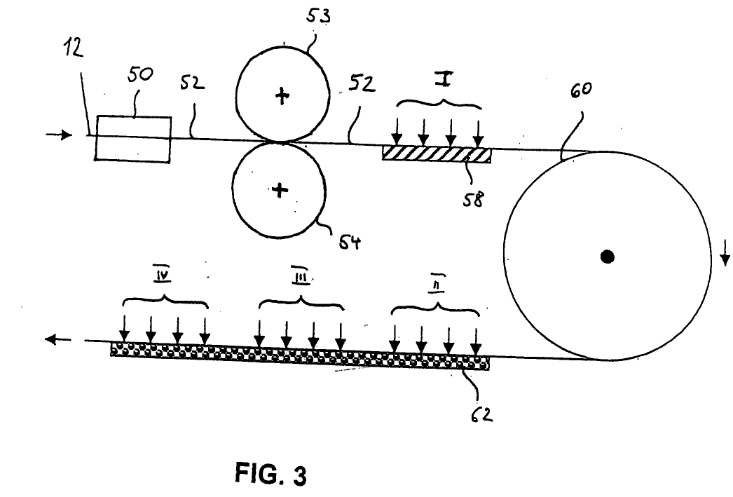

In order to manufacture the individual cell described thus far, a method can be applied as will be described below with reference to FIG. 3. An individual continuous wire 12 (alternatively several wires simultaneously) is introduced into a knitting device 50, where it is knit into a knit band 52 in keeping with the specifications, which continually leaves the knit device 50. According to the entanglement, an above described, so-called gradation can be introduced into the knit. (That is, a locally different knit density or the like can be generated in order to obtain different flow resistances.) Moreover, the properties of the knit, especially in chemical aspects, are determined by the condition of the wire.

The continuous knit band 52 is then fed to a roller unit that comprises an upper roller 53 and a lower roller 54 in which it is rolled. The rollers 53 and 54, however, perform multiple functions. For example, the upper roller 53 is equipped with impressing stamps which are oriented transversely toward the run-through direction of the knit band 52, and which alternatingly impress diverging flow channels (as shown in FIG. 2 under reference number 16) into the knit 10 or the knit band 52. In addition, the two electrically conducting rollers 53 and 54 are acted upon by current so that when the knit band 52 passes through, the wires 12 that are lying one on top of the other are welded together. In this way (as already mentioned above), an especially low ohmic resistance is attained inside the knit 10, which has positive effects for the discharge of electrons from the individual fuel cell.

The knit band 52 processed in this manner is then guided over a dense foundation 58 and irradiated from the opposite side in a coating process I using a plasma spraying method with a condensing material or anode material. This anode material is fixed in place in the area of the dense foundation 58, on the surface of the knit 10 or knit band 52 there, in the form of a so-called depositing, and forms a so-called cover layer 11 (or first surface coating) of the knit 10 (or 52) (and indeed on its “underside”), which advantageously can at the same time be used as an anode. In order to prevent the anode material from becoming joined to the solid foundation 58, it can also be provided with a separating agent.

Of course, the coating process I is also continuous. Here, nickel or a nickel alloy-ZrO₂ mixture can be used as the condensing material. Following a deflection or rotation, for example on a deflecting roller 60, of the knit band 52, which has already been provided with a thin cover coating 11 on the anode side, an application of a very thin anode coating takes place in a further coating process II, which coating connects to the cover coat 11 that was applied previously in coating process I and also functions as an anode coating and forms the overall anode (cf. FIG. 1 letter A). The rotation of the knit band 52 for the coating process II is necessary in order to be able to apply the material once again from above, after (as was discussed) the material has been introduced through the knit band 52 into its underside there.

In addition, in the coating process II an especially smooth anode surface can be obtained since the knit band 52 is guided or stressed over a convex bracing surface 62 (on a plane perpendicular to the drawing plane), as was explained above. Overall, a very thin and advantageously smooth anode surface can be obtained with the procedure from steps I and II. The electrolyte (E, cf. FIG. 1) is likewise applied subsequently to the CEA unit in a coating process III via a plasma spraying method, and the cathode material (C) is applied in a coating process IV. When plasma spraying is used, a direct voltage excitation is used, wherein the respective coating material is made available in the form of a powder. All coating processes I, II, III and IV run continuously with a constantly progressing knit band 52. Further cleansing steps can be provided between the individual manufacturing steps. In addition, the respective thermal spraying processes take place in separate chambers with sluices, and preferably under a protective gas atmosphere, so that oxidation processes and alternate impurities are avoided to the greatest possible extent.

At the end of the manufacturing process, individual cell structures can be obtained by making the coated knit band 52 to length, such as by cutting (for example with laser or water stream). These individual cells can then be further processed into a fuel cell stack. In this, steps such as fixing, sealing, contacting etc. are to be conducted. The method of the invention overall presents a simple and extremely economical manufacturing possibility for individual fuel cells, which for their part have especially beneficial properties with respect to thermo-mechanical tensions, owing to the construction of the invention, and are especially well-suited for non-stationary use as well.

It is apparent that other (known) manufacturing methods could be used as an alternative to the continuous production method described above. Also, it is possible to knit bands first and then to cut these to length (for example winding and laying the bands). After extruding the prepared parts into plate components in so-called matrices, a so-called spraying barrier and/or support layer for the CEA unit can be applied. Thereafter, the coatings for the electrodes and the electrolytes can be applied in further steps. Basically the operations mentioned here are applicable in a comparable manner to other support structures constructed of metal wire or wires (for example, weaves, plaits or fabrics); and it should further be pointed out that a large number of details can also be configured to deviate from the presentations above without departing from the invention. In particular, the protected fuel cell as a component is not restricted to a porous support structure 10 formed from a knit. Rather, fabrics, plaits and weaves comprised of metal wires 12 can also be used for this.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fuel cell comprising a stack of:
at least one individual cell with a cathode-electrolyte-anode unit; and
at least one bipolar plate; wherein,
the individual cell comprises a porous support structure for the cathode-electrolyte-anode unit applied thereupon; and
the porous support structure comprises a material selected from the group consisting of a metal knit, weave and plait.

2. The fuel cell according to claim 1, wherein the porous support structure is arranged between the cathode-electrolyte-anode unit and the bipolar plate.

3. A fuel cell comprising a stack of:
at least one individual cell with an cathode-electrolyte-anode unit, at least one bipolar plate, and a porous support structure upon which the cathode-electrolyte-anode unit is applied; wherein,
the porous support structure through which a fluid flows possesses a changing flow resistance in the flow direction and/or perpendicular thereto; and
the porous support structure comprises a material selected from the group consisting of a metal knit, weave or plait.

4. The fuel cell according to claim 3, wherein the changing flow resistance is attained by one of a change in wire thickness of the wire that forms the support structure, a change of mesh density, a change of material density, and changing the shape of the mesh or the surface condition of the loops in the support structure variously selected during manufacture of the support structure.

5. The fuel cell according to claim 3, wherein the changing flow resistance is achieved by a broadening of the flow cross section.

6. The fuel cell according to claim 5, wherein the changing flow resistance is achieved by diverging channels in the support structure.

7. The fuel cell according to claim 1, wherein the support structure wires comprise at least one material selected from the group consisting of nickel, ferritic or austenitic alloys, and high-grade steel.

8. The fuel cell according to claim 1, wherein the support structure wire is at least partially coated with a corrosion-resistant material.

9. The fuel cell according to claim 1, wherein the support structure comprises wires of differing material dimensions or surface.

10. The fuel cell according to claim 1, wherein edge bands or edge strips are provided on the support structure and/or porous reinforcement coatings, or porous foil are applied to the surface of the support structure.

11. The fuel cell according to claim 1, wherein the wires of the support structure are connected firmly to one another on their contact and bearing points, by one of gluing, soldering, sintering or welding.

12. The fuel cell according to claim 1, wherein an anode is applied provided on the support structure, followed the electrolyte applied to the anode, and the cathode applied to the electrolyte.

13. The fuel cell according to claim 12, wherein a mixture is used, said mixture including ZrO₂ and an additional constituent selected from the group consisting of nickel, a nickel alloy, and a nickel-aluminum alloy.

14. A method for manufacturing a fuel cell which includes a stack of at least one individual cell with an cathode-electrolyte-anode unit and at least one bipolar plate, wherein the at least one individual cell comprises a porous support structure built up of metal wire in the form of a knit or weave or plait or fabric on which the anode-electrolyte-cathode unit is applied, said method including:
forming the support structure from metal wires; and
subsequently applying the cathode-electrolyte-anode unit to the support structure.

15. The method according to claim 14, wherein in the subsequent successive application of the cathode-electrolyte-anode unit, a first electrode layer is applied to the support structure, after which the electrolyte is applied to the first electrolyte layer, and subsequently a second electrode layer is applied to the electrolytes.

16. The method according to claim 14, wherein during or after construction of the support structure and prior to the application of an electrode layer in or on the support structure, a spraying barrier or stream brake is introduced onto the surface of the support structure or into the support structure into the vicinity of its surface.

17. The method according to claim 16, wherein wires made of a material that can be subsequently dissolved, is woven or knitted into the support surface as a spraying barrier or stream brake.

18. The method according to claim 17, wherein:
the wires are comprised of aluminum; and
following application of the electrode layer or layers to the support structure, the aluminum wires are washed out.

19. The method according to claim 17, wherein:
the wires are comprised of carbon; and
the wires are dissolved or reacted out using oxygen or hydrogen following the application of the electrode coating or coatings to the support structure.

20. The method according to claim 16, wherein a filler compound is introduced on the electrode side into the support structure as a spraying barrier or stream brake.

21. The method according to claim 20, wherein the filler mass is removed temporally during or following the application of the electrode coating or coatings to the support structure.

22. The method according to claim 20, wherein:
a filler compound is used; and
the filler compound comprise a material selected from the group consisting of a ceramic, a metal and a graphite slop.

23. The method according to claim 20, wherein the filler compound is removed during or following the application of the electrode layer or layers to the support structure.

24. The method according to claim 16, wherein a graphite foil is provided as a spraying barrier or stream brake on the electrode side or into the support structure.

25. The method according to claim 16, wherein:
the support structure is laid on a dense foundation; and
the spraying barrier or stream brake is produced using a thermal injection method; and
a depositing or cover layer is generated near the dense foundation by irradiation of the support structure.

26. The method according to claim 25, wherein the deposition or cover layer forms at least a part of the electrode layer.

27. The method according to claim 14, wherein intermediate spaces of the layer of the support structure near the anode are filled with a filler compound mixed with pore formers.

28. The method according to claim 14, wherein the layer of the support structure near the anode is sintered prior to application of the electrode layer with a porous cover layer comprising a metallic, ceramic or metal-ceramic material.

29. The method according to claim 14, wherein a porous foil made of an electrically conductive material, is applied to the electrode side of the support structure before the electrode coat is applied.

30. The method according to claim 29, wherein porosity of the foil is generated after it is applied, mechanically or electrochemically or thermally.

31. The method according to claim 14, wherein:
the electrode layer or layers, are applied with a thermal coating method to the support structure; and
a spraying barrier or stream brake or cover layer prevents an excessive penetration of the electrode material into the support structure.

32. The method according to claim 31, wherein a flame spraying method or a plasma spraying method, especially an atmospheric plasma spraying, a vacuum plasma spraying, or a low pressure plasma spraying method is used as the thermal coating method.

33. The method according to claim 14, wherein an electrode support layer or cover layer is applied as a first layer to the support structure on which the active electrode is applied, and nickel, a nickel alloy or a nickel-aluminum alloy is used for the electrode base layer.

34. The method according to claim 14, wherein one of a metal wire skeleton, a wire fabric, a wire lattice or longitudinal wires are worked into the support structure as strength increasing elements, prior to a thermal coating process on the support structure.

35. The method according to claim 34, wherein edge bands or edge strips made of metal foil, are worked into the support structure, or the edge of the support structure is extruded suitably to form an edge strip.

36. The method according to claim 14, wherein wires of the support structure that lie one on another are connected to one another by one of gluing, soldering, sintering and welding electric resistance welding or cold welding.

37. The method according to claim 36, wherein after the support structure has been produced, metallic electrodes are laid on the upper side and under side of the support structure, and are subjected to a current impulse to join the wires that form the support structure.

38. The method according to claim 36, wherein the support structure is continuously passed through linear electrodes, plates, or rollers for continuous welding.

39. The method according to claim 14, wherein the support structure is connected with the bipolar plate by a method selected from the group consisting of cold welding, welding, soldering and sintering.

40. The method according to claim 14, wherein at least one of mesh width, loop density, the loop arching, a shape of the mesh of the support structure, and thickness of the wire used to form the support structure, is changed during its construction such that a flow resistance which is different over the length and thickness arises in the support structure.

41. The method according to claim 14, wherein diverging channels are constructed with a changing flow cross-section in the support structure.

42. The method according to claim 41, wherein the diverging channels are constructed during the building of the support structure by choice of one of wire thickness, mesh density and loop shape.

43. The method according to claim 41, wherein the diverging channels are formed after the construction of the support structure by imprinting or impressing.

44. The method according to claim 41, wherein the support structure is stressed in individual operations especially over a convex foundation surface.

45. The method according to claim 14, wherein:
the support structure is continuously manufactured in the form of a band; and
subsequent production steps are performed in a continuous operation.
